(19) United States
(12) Patent Application Publication
(10) Pub. No.: US 2009/0119122 A1
(43) Pub. Date: May 7, 2009

(54) Retail Item - Offset Pairing for Neutral Environmental Impact

(75) Inventors: Dan Whaley, San Francisco, CA (US); Margaret Leinen, Alexandria, VA (US); Kevin Whilden, San Francisco, CA (US)

Correspondence Address: FENWICK & WEST LLP, SILICON VALLEY CENTER, 801 CALIFORNIA STREET, MOUNTAIN VIEW, CA, 94041, US

(73) Assignee: Climos, San Francisco, CA (US)

(21) Appl. No.: 12/267,495

(22) Filed: Nov. 7, 2008

Related U.S. Application Data
(60) Provisional application No. 60/986,281, filed on Nov. 7, 2007.

(51) Int. Cl. G06Q 10/00

(52) U.S. Cl. 705/1

(57) ABSTRACT

Systems and methods for pairing negative and positive environmental impacts are disclosed. The system and methods include pairing negative environmental impacts from retail item production and manufacturing with positive environmental impacts from projects, resulting in retail items that are neutral with respect to environmental effects. The systems and methods offset negative environmental impact for retail items by determining a positive environmental impact associated with a project and calculating micro-units based on the amount of negative impact from each retail item. A unique identifier is assigned to each micro-unit and the micro-unit-retail unit pairing is stored. The system can be implemented via a computer system.

### RELATED APPLICATION

This application claims the benefit of U.S. Patent Provisional Application No. 60/986,281, entitled “System And Methods For Generating and Inventorying Sequestered Carbon,” filed Nov. 7, 2007, and is related to U.S. application Ser. No. 12/267,368, entitled “Quantification and Quality Grading for Carbon Sequestered Via Ocean Fertilization,” filed Nov. 7, 2008 and U.S. application Ser. No. 12/267,405, entitled “Ocean Fertilization Project Identification and Inventorying,” filed Nov. 7, 2008, each of which are incorporated herein by reference for all purposes.

### FIELD OF THE INVENTION

This invention relates generally to the field climatology. More specifically, the present invention relates to systems and methods for offsetting negative environmental impacts associated with retail items such as goods or services. These system and methods are used in conjunction with various positive environmental impact projects and technologies to result in retail items, i.e., goods or services with neutral impact on the environment. The systems and methods are useful for countering greenhouse gas emissions, resources consumed, and toxic by-products resulting from manufacturing of retail items.

### BACKGROUND OF THE INVENTION

Most products and services have a negative impact on the environment in the consumption of resources and/or negative effect of emissions from their manufacture and/or use. Via consideration of the lifecycle of a product or service, the approximate effect from the product can be ascertained. For example, a lifecycle analysis comprising all or a portion of the lifecycle for the retail item may include the extraction of resources as raw materials for the item, the energy consumed and by-products of manufacture of the item and its packaging, energy and pollution associated with transport of the item and/or its presence in retail, greenhouse gas emissions, pollution, energy use, and other impacts associated with use of the item, and energy and other negative impacts associated with disposal and/or recycling.

In contrast, many projects now exist that attempt to help reverse the negative effects of manufacturing and other use. For example, emission reduction approaches include the use of alternative energy sources, such as solar power, wind power, geothermal power, fuel cell technology, in addition to increasing the use of more traditional clean sources of energy such as hydroelectric power. Reducing greenhouse gas emissions provides an important component of the overall strategy for reducing greenhouse gas levels. Other strategies focus on removal of existing negative environmental factors. For example, greenhouse gas levels also can be reduced by actively removing carbon dioxide from the atmosphere by stimulating the growth of photosynthetic organisms. Photosynthesis removes carbon dioxide from the atmosphere or water and incorporates or “fixes” it into the structure of the living organism.

Despite the balancing effect that could be attained by pairing these negative and positive environmental impact sources, to date no one has effectively monetized these pairings. Conventional offsets against environmentally negative factors have been on large and mega scales, with companies purchasing large amounts of offsets that they can advertise as such, but that are not closely tied to the retail items associated with the company or offset. The purchasers of products with the pairings are not able to independently identify and verify the analysis of impacts or the existence of the pairings. The present invention addresses these needs and other shortcomings of the prior art by providing systems and methods for pairing negative and positive environmental effects at the individual or batch item level.

### SUMMARY

Systems and methods for pairing negative and positive environmental impacts are disclosed. The systems and methods include pairing negative environmental impacts from production and manufacturing of retail items, i.e., goods or services with positive environmental impacts from projects producing offsets for such negative effects. Through this pairing, retail items can be made be “neutral” with respect to environmental effects.

One embodiment includes a system and method for offsetting a negative environmental impacts associated with retail items, including determining a negative environmental impact associated with a retail item, determining a positive environmental impact associated with a project, calculating micro-units of positive environmental impact based on the amount of negative impact from each retail item, assigning a unique identifier to each micro-unit, and storing an association of the micro-unit-retail unit pairing. Embodiments of the invention can be implemented via a computer, though other implementations can be used as well.

### BRIEF DESCRIPTION OF THE DRAWINGS

FIG. 1 is a conceptual diagram showing an offset manager and affiliated entities for offsetting environmental impact of retail items according to one embodiment of the present invention.

FIG. 2 is a high-level block diagram of a computer system for implementing the methods of the present invention according to one embodiment.

FIG. 3 is a block diagram of a memory unit of the computer system according to one embodiment of the present invention.

FIG. 4 is a flowchart illustrating a method of offsetting negative environmental impact associated with retail items in accordance with one embodiment of the present invention.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION

As described herein, methods and systems are described for making retail items “neutral” by assessing the resources consumed and impacts calculated in the production and distribution of items, and also potentially in the lifecycle of their use and disposal or recycling and offsetting that negative impact using micro-units of positive environmental impact produced by projects that create such positive impact.

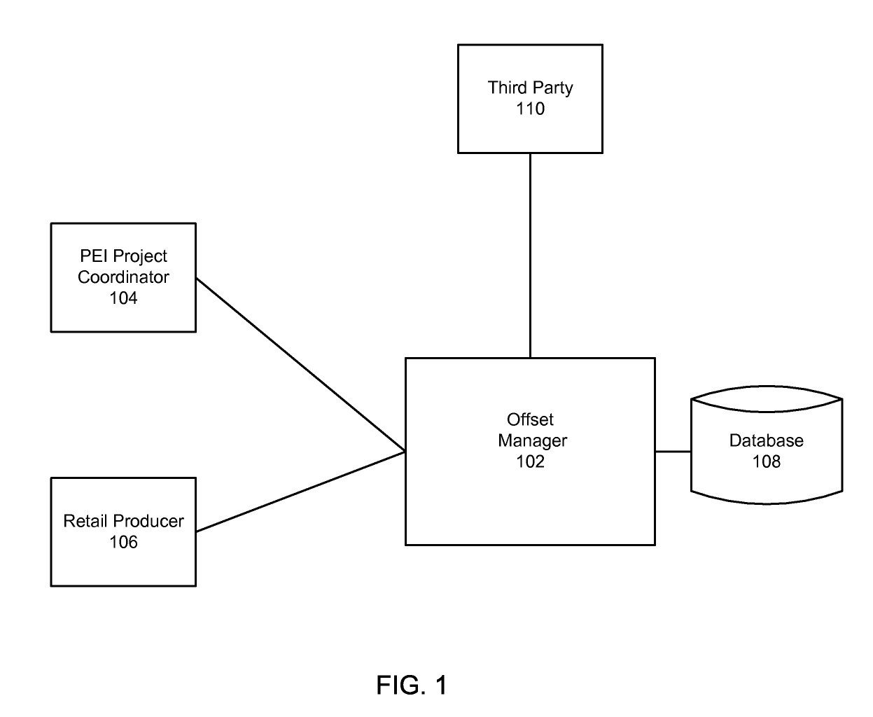

FIG. 1 is a conceptual diagram showing an offset manager 102 and affiliated entities for offsetting environmental impact of retail items according to one embodiment of the present invention.

The offset manager 102 provides services and information as described herein for pairing negative environmental impact associated with retail goods with positive environmental impact associated with projects for that purpose according to one embodiment of the present invention. In addition, calculating the offset value, accounting for the values, tracking negative environmental impact, and pairing the impact with offsets are provided by the offset manager 102 according to some embodiments of the present invention. The pairing allows a producer 106 of retail items to environmentally “neutralize” those items by purchasing environmentally positive “micro-offsets,” e.g., produced by positive environmental impact (PEI) projects and project coordinators 104, that are equal in value to the negative environmental impact of the retail items on an item or batch/lot basis. In so doing, the producer 106 can label or otherwise identify the product as associated with the micro-offset. The negative environmental impact of retail items may be stored in the database 108, with or without paired micro-unit offset information. This information may be made available to retailers and/or credit card processors for providing the user a listing of the negative impacts and paired offsets of the products and services they consume.

The offset manager 102 collects data from the PEI project coordinators 104 for various projects and from various producers 106 interested in purchasing the offsets. The offset manager 102 may calculate the positive and negative environmental impacts from raw data provided by these entities 104, 106, and/or may verify the pre-calculated values provided to it, e.g., by the entities 104, 106 or by a third-party calculator such as a national consortium of universities, greenhouse gas regulators, or independent registries, according to one embodiment of the present invention. The offset manager 102 also may broker the offset purchase transactions according to one embodiment, as described further below.

The offset manager 102 calculates the number of micro-units of positive environmental impact associated with a project by dividing the number of units of positive environmental impact associated with the project by the negative environmental impact corresponding to the retail item. For example, for CO2, the number of units of positive environmental impact associated with a project would traditionally be in metric tons of CO2 stored or removed. As an example, assume a project removed 1,000 tons of CO2. The negative environmental impact of a single retail item, e.g., a pair of leather boots, represents a carbon footprint of approximately 120 pounds. Dividing the 1,000 tons by the negative impact of the pair of boots (1,000 metrics tons=2,204,600 pounds/120 pounds) yields 18,372 pairs of boots that can be offset by the project.

The offset manager 102 assigns a unique identifier to each micro-unit, and records pairings between specific micro-units and specific retail goods, as well as additional information associated with each, and makes the information available to third parties.

One or more PEI project coordinators 104 provide information to the offset manager 102 regarding various projects with a positive environmental impact with which they are associated, and a value associated with the positive impact. The positive environmental impact of a project may be associated with various contributing factors (e.g., conservation of resources, replenishment of resources, removal of toxins, etc.), all of which may be included in the positive environmental impact of the project. In one embodiment, this data is drawn from a carbon registry.

A non-exclusive list of types of positive environmental impacts includes: reductions in greenhouse gases (e.g., CO2, N2O, CH4, HFCs, etc.), reductions in toxic air emissions (e.g., NO2, NO3, SO2, SO3, SO4, soot, ozone, etc.), conservation and restoration of biological resources (e.g., wetland mitigation banking, ecosystem service banking, endangered species banking, biodiversity offset projects, sustainable forestry projects, payments to protect watersheds, etc.), pollution mitigation projects (e.g. landfill cleanup), and socio-economic and community benefits (e.g., preservation of native communities and culture, increases to economic well-being, etc.). See Climate Community and Biodiversity Standards (http://www.climate-standards.org/standards/pdf/draft_second_edition_ccb_standards_version_{—}2_{—}0.pdf), the National Mitigation Banking Association (http://www.mitigationbanking.org), and Building Biodiversity Business (http://earthmind.net/bbb/docs/iucn-shell-2008-bbb-report.pdf).

The units of exchange used to calculate micro-offset quantities between pairings depends on the type of positive and negative effects. For greenhouse or toxic gas emissions and reductions, metric tons (or other weight unit) is a convenient choice for both positive and negative effects. For other effects that affect watersheds, forestry, or land conservation, the unit might be area (e.g., hectacres). Effects that do not have an obvious unit of exchange may use dollars as a convenient proxy (e.g., a manufacturer of a product may fund a restoration project that protects an endangered species such as red-ruffed lemurs or blue elfin butterflies), and this cost (or alternatively the economic value of the protected biodiversity) would be compared against the value of the product created by the manufacturer. Furthermore, new standards and units of measure may emerge in the future that allow a more effective pairing of positive and negative effects.

One or more retail producers 106 are producers or manufacturers of goods or services. The retail producer 106 may provide the offset manager 102 with raw data and/or values corresponding to the negative environmental impact associated with retail items. The negative environmental impact may include multiple negative impact types, e.g., GHG emissions, air pollution of various types, hazardous materials by-products, habitat or biodiversity loss, etc. In addition, the negative environmental impact unit information may be provided with information detailing the calculation of the units, including a listing of any factors considered or not. In some embodiments, the retail producer 106 may work in conjunction with a regulatory or standards agency or other third-party consultant to determine its negative environmental impact.

A database 108 is associated with the offset manager 102 for storage of information regarding the retail items and the PEI project offsets, the identifiers associated with each, and their pairings. The database 108 is a conventional type and stores the information used according to the methods of the present invention. The database 108 may be a federation of databases. In one embodiment, the database 108 may be remote from the offset manager 102.

Access to the database 108 may be by any methods known in the art, including the use of uniform resource locators (URLs), standard database querying, a web interface, etc. Similarly, a UPC code associated with a product may include information about the stored data by individual items or via a roster of resources consumed and impacts created.

Various users 110 may be associated with the offset manager 102 and may access information from the database 108. The information may be accessible at various levels for various purposes. For example, a producer or manufacturer may want to access the information for reporting, marketing, or product labeling purposes. In addition, a third party 110, such as a consumer of the retail item, a standards or regulatory agency, etc. may want to access the various data associated with the retail item-micro-unit pairing.

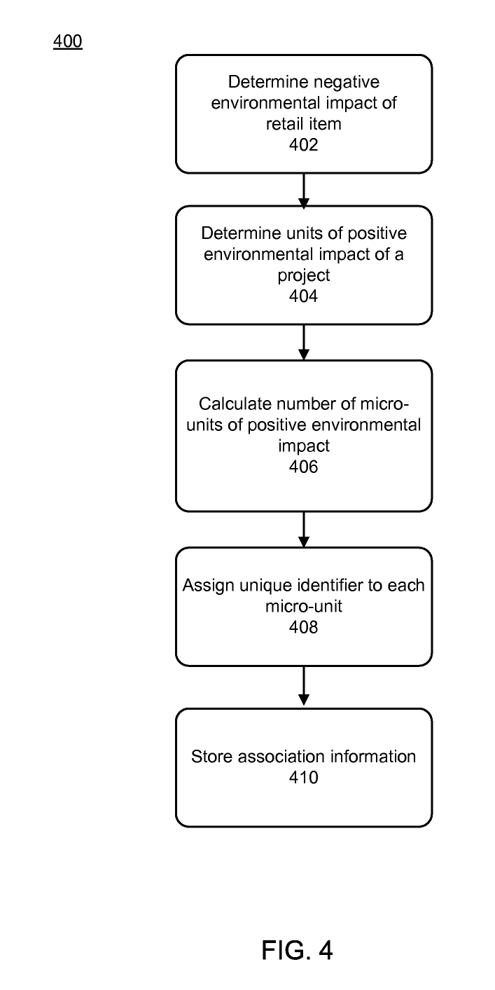

In one embodiment, the third party 110 is a credit card processor. The credit card processor is provided with information regarding the negative environmental impact associated with various retail items, and whether some or all of the negative impact have been offset by a positive environmental impact. The environmental impact information received by the retailer is provided to the purchaser on his or her credit card receipt according to one embodiment. FIG. 4 below describes the methods of the present invention, and shows the roles that each of the entities of FIG. 1 plays in the methods.

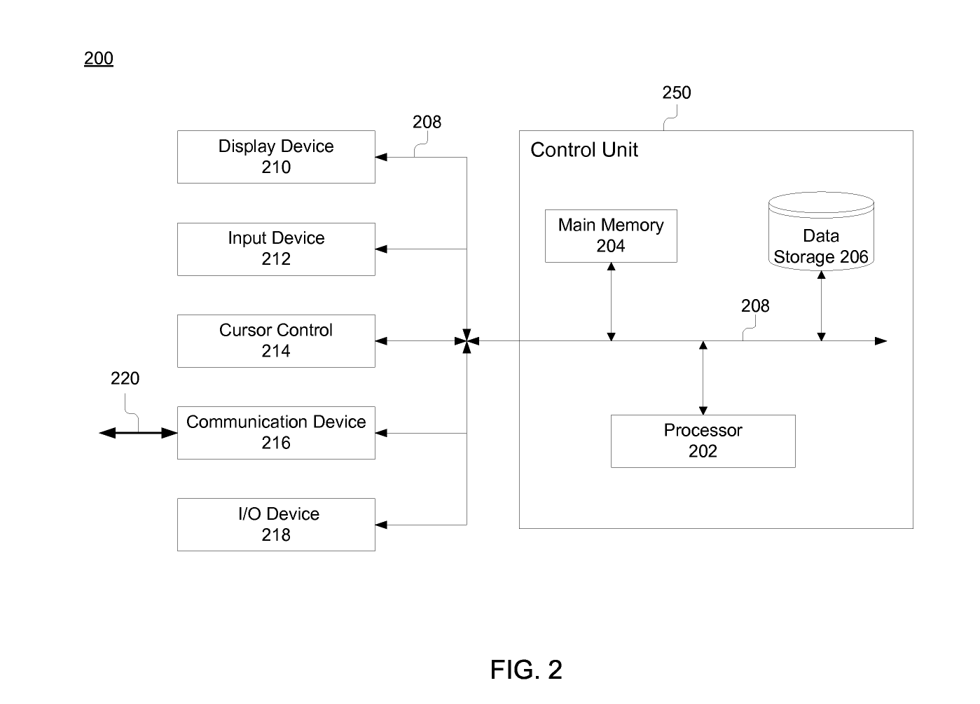

Referring to FIG. 2, there is shown a high-level block diagram of a computer system 200 for implementing the methods of the present invention according to one embodiment. The computer system 200 can act as a client computer, a server, etc. The computer system 200 resides with the offset manager 102 according to one embodiment. Illustrated is a control unit 250, which includes a processor 202, a main memory 204, and a data storage 206 coupled to a bus 208. Also coupled to the bus 208 are a display device 210, an input device such as, e.g., a keyboard 212, a cursor control 214, a communication device 216, and an I/O device 218.

The processor 202 may be any general-purpose processor such as an INTEL x86, SUN MICROSYSTEMS SPARC, or POWERPC compatible-CPU, or the processor 202 may also be a custom-built processor. Processor 202 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included.

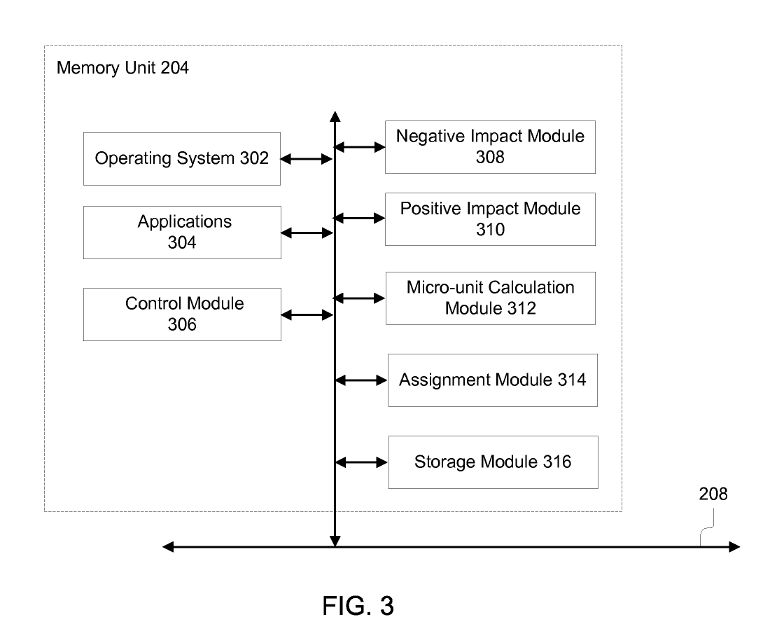

Main memory 204 stores instructions and/or data that may be executed by processor 202. The instructions and/or data may comprise code for performing any and/or all of the techniques described herein. Main memory 204 may be a dynamic random access memory (DRAM) device, a static random access memory (SRAM) device, or some other memory device known in the art. The memory 204 is described in more detail below with reference to FIG. 3. All or some of the contents of the memory 204 may be housed on a computer-readable storage medium.

Data storage device 206 stores data and instructions for processor 202 and comprises one or more devices including a hard disk drive, a floppy disk drive, a CD-ROM device, a DVD-ROM device, a DVD-RAM device, a DVD-RW device, a flash memory device, or some other mass storage device known in the art.

System bus 208 represents a shared bus for communicating information and data throughout control unit 250. System bus 208 may represent one or more buses including an industry standard architecture (ISA) bus, a peripheral component interconnect (PCI) bus, a universal serial bus (USB), or some other bus known in the art to provide similar functionality. Additional components coupled to control unit 250 through system bus 208 include the display device 210, the input device 212, cursor control 214, the communication device 216 and the I/O device(s) 218.

Display device 210 represents any device equipped to display electronic images and data as described herein. In one embodiment, the display device 210 is a liquid crystal display (LCD) and light emitting diodes (LEDs) to provide status feedback, operation settings and other information to the user. In other embodiments, the display device 210 may be, for example, a cathode ray tube (CRT) or any other similarly equipped display device, screen or monitor.

In one embodiment, the input device 212 is a keyboard. The keyboard can be a QWERTY keyboard, a key pad, or representations of such created on a touch screen. Cursor control 214 represents a user input device equipped to communicate positional data as well as command selections to processor 202. Cursor control 214 may include a mouse, a trackball, a stylus, a pen, a touch screen, cursor direction keys, or other mechanisms to cause movement of a cursor.

Communication device 216 links control unit 250 to a network 220 that may include multiple processing systems and in one embodiment is a network controller. The network of processing systems may comprise a local area network (LAN), a wide area network (WAN) (e.g., the Internet), and/or any other interconnected data path across which multiple devices may communicate. The control unit 250 also has other conventional connections to other systems such as a network for distribution of files (media objects) using standard network protocols such as TCP/IP, http, https, and SMTP as will be understood to those skilled in the art.

One or more I/O devices 218 are coupled to the bus 208. These I/O devices may be part of the other systems (not shown).

It should be apparent to one skilled in the art that computer system 200 may include additional or fewer components than those shown in FIG. 2 without departing from the spirit and scope of the present invention. For example, additional input/output devices 218 may be coupled to control unit 250 including, for example, an RFID tag reader, digital still or video cameras, or other devices that may or may not be equipped to capture and/or download electronic data to control unit 250. One or more components could also be eliminated such as the keyboard 210 & cursor control 212.

As is known in the art, the computer system 200 is adapted to execute computer program modules for providing functionality described herein. In this description, the term “module” refers to computer program logic for providing the specified functionality. A module can be implemented in hardware, firmware, and/or software. Where the any of the modules described herein are implemented as software, the module can be implemented as a standalone program, but can also be implemented in other ways, for example as part of a larger program, as a plurality of separate programs, or as one or more statically or dynamically linked libraries. It will be understood that the modules described herein represent one embodiment of the present invention. Certain embodiments may include other modules. In addition, the embodiments may lack modules described herein and/or distribute the described functionality among the modules in a different manner. Additionally, the functionalities attributed to more than one module can be incorporated into a single module. In one embodiment of the present invention, the modules are stored on the data storage 206, loaded into the memory 204, and executed by the processor 202. Alternatively, hardware or software modules may be stored elsewhere within the computer system 200.

Referring now to FIG. 3, it shows a block diagram of a memory unit 204 of the computer system 200 according to one embodiment of the present invention.

The memory unit 204 comprises an operating system 302, applications 304, a control module 306, a negative impact module 308, a positive impact module 310, a micro-unit calculation module 312, an assignment module 314, a storage module 316, and an offset brokering module 318. Those skilled in the art will recognize that the memory 204 also includes buffers for storing data and other information temporarily during the processes associated with the methods described herein. As noted above, the memory unit 204 stores instructions and/or data that may be executed by processor 202. The instructions and/or data comprise code for performing any and/or all of the techniques described herein. These modules 302-318 are coupled by bus 208 to the processor 202 for communication and cooperation with other aspects of the system 200.

The operating system 302 may be one of a conventional type such as, WINDOWS®, Mac OS X®, SOLARIS® or LINUX® based operating systems, or may be a custom operating system that is accessible to user via an application interface.

The memory unit 204 includes one or more application programs 304 including, without limitation, drawing applications, word processing applications, electronic mail applications, search application, and financial applications. In one embodiment, the applications 304 specifically utilize the unique capabilities of the other modules or units of memory 204.

The control module 306 is adapted for control of and communication with the other modules of the memory 204. The operation of the control module 306 will be apparent from the description of the figures below. While the control module 306 is shown as a separate module of the memory 204, those skilled in the art will recognize that the control module 306 in another embodiment may be distributed as routines in the other modules.

The negative impact module 308 is software and routines for determining the negative environmental impact associated with a retail item. This determination may include an assessment of the entire lifecycle of the item, or a smaller portion such as the lifecycle until it reaches the consumer. The determination also may include calculation from raw data. The negative environmental impact may include multiple negative impact types, and may be calculated in a selected, standardized unit. The negative impact module 308 is connected to system bus 208 for communication with the operating system and other modules.

The positive impact module 310 is software and routines for determining the positive environmental impact associated with a project. The positive environmental impact of a project may be associated with various contributing factors (e.g., conservation of resources, replenishment of resources, removal of toxins, etc.), all of which may be included in the positive environmental impact of the project. The determination may include calculation from raw data. The positive impact module 310 may assess the accuracy of the impact value. The positive impact module 310 is connected to system bus 208 for communication with the operating system and other modules.

The micro-unit calculation module 312 is software and routines for calculating the number of micro-units of positive environmental impact associated with a project by dividing the number of units of positive environmental impact associated with the project by the negative environmental impact corresponding to the retail item. The micro-unit calculation module 312 is connected to system bus 208 for communication with the operating system and other modules.

The assignment module 314 is software and routines for assigning a unique identifier to each of the micro-units. If immediate information is not available about the pairing of the micro-units with the retail items, the assignment module makes an initial identification of a set of unique identifiers equal in number to the number of micro-units for the project. If the retail item information is available, the assignment module 314 includes pairing each micro-unit, by its unique identifier, to a retail item, e.g., by its retail identifier such as a serial number or lot number. In some examples the assignment is not one-to-one. The assignment module 314 is connected to system bus 208 for communication with the operating system and other modules.

The storage module 316 is software and routines for storing association information. The information may be stored in a local or remote database and may be accessible at various levels for various purposes. The storage module 316 monitors access to the stored information, e.g., my monitoring database access. The storage module 316 is connected to system bus 208 for communication with the operating system and other modules.

The offset brokering module 318 is software and routines for brokering negative impact-positive impact pairings. When a retail producer 106 wants to offset a particular good or service, the can do so with professional assistance from the offset manager 102. The offset brokering module 318 is connected to system bus 208 for communication with the operating system and other modules.

Those of skill in the art will recognize that other embodiments can have different and/or additional modules than those shown in FIG. 3. Likewise, the functionalities can be distributed among the modules in a manner different than described herein.

### Establishing a Neutral Environmental Impact

Referring now to FIG. 4, a flowchart 400 is shown illustrating a method of offsetting negative environmental impact associated with retail items in accordance with one embodiment of the present invention. In general, the negative environmental impact associated with the lifecycle of retail items is offset using micro-units of positive environmental impact produced by projects that create such positive impact. By so doing, the retail item can be said to be “neutral” with respect to its effect on the environment—that the negative impact that normally would be associated with the retail item has been “offset” by pairing it with an equal positive environmental impact.

As used herein, retail items may include individual goods sold in the retail market (e.g., a pair of shoes, a child's toy, a gallon of milk, etc.), services sold in the retail market (e.g., carpet cleaning, vehicle repair, a spa treatment, etc.), or lots of goods or services (e.g., a case of soda cans, a bundle of lumber, etc.).

The negative environmental impact for the lifecycle of a retail item may include a “cradle-to-grave” analysis for the product, including the extraction of resources as raw materials for the item, the energy consumed and by-products of manufacture of the item and its packaging, energy and pollution associated with transport of the item and/or its presence in retail, energy and other impacts associated with use of the item, and energy and other toxic impacts associated with disposal and/or recycling. Alternatively, only a portion of the lifecycle may be included in the negative environmental impact consideration, e.g., the portion until it reaches the end user/consumer.

The method begins by determining 402 the negative environmental impact associated with a retail item. As discussed above, this determination may include an assessment of the entire lifecycle of the item, or a smaller portion such as the lifecycle until it reaches the consumer. In some instances, the value associated with the negative environmental impact may be a fraction of the number associated with the manufacture, etc. of a large number of the item divided by the number of items, i.e., such that the value reflects an approximate per item impact. In other instances, variances in portions of the lifecycle, e.g., amount of fossil fuel used to power multiple machines of unequal efficiency, may be accumulated values such that the negative environmental impact is an average.

The negative environmental impact may include multiple negative impact types, e.g., energy consumption, air pollution of various types, hazardous materials by-products, habitat destruction etc. Thus, the negative environmental impact for a retail item may be calculated in a selected unit, e.g., tons of CO2, and all other emissions or other negative impacts calculated into the selected units to determine the cumulative impact of the various negative impact types. For example, if a negative impact includes gases such as nitrous oxide (N₂O), methane (CH₄), the carbon dioxide equivalent of these greenhouse gases could be calculated using the global warming potential of the gas. Toxic air emissions and other forms of pollution could be measured in terms of mass (e.g., tons), volume (e.g., gallons), or in terms of financial impacts to health and ecosystem services (e.g., dollars). Destruction of habitat, wetlands, biodiversity, watersheds, forests, etc. could be measured in terms of area (e.g., hectacres), or in terms of lost ecosystem services or other revenue (e.g., dollars). Destruction of endangered species could be measured in terms of ecosystem services or lost tourism revenue (e.g., dollars). Destruction of socio-economic or community resources could be measured in dollars.

The determination 402 of the negative environmental impact for the retail item may be calculated by the offset manager 102, or may be a value received by the offset manager 102 from the manufacturer or a third party, e.g., a standards board or environmental consultant assessment company. The offset coordinator 102 may or may not assess the accuracy of the impact value according to various embodiments. In addition, the negative environmental impact unit information may be accompanied by information detailing the calculation of the units, including a listing of any factors considered or not.

Next, the number of units of positive environmental impact is determined 404 as associated with a selected project. As above, the positive environmental impact of a project may be associated with various contributing factors (e.g., conservation of resources, replenishment of resources, removal of toxins, etc.), all of which may be included in the positive environmental impact of the project. Also as above, the units corresponding to the positive environmental impact may be standardized for determining the cumulative effect across types of impacts. The offset manager 102 may retrieve the impact value from a local or remote database, may calculate the value from raw data (e.g., received from a PEI project coordinator 104), or may receive the impact value information as a whole from a PEI project coordinator 104 or other third party. The offset coordinator 102 may or may not assess the accuracy of the impact value according to various embodiments. In addition, the positive environmental impact unit information may be accompanied by information detailing the calculation of the units, including a listing of any factors considered or not. Removal of greenhouse gases or toxic air emissions and other forms of pollution could be measured in terms of mass (e.g., tons), volume (e.g., gallons), or in terms of financial impacts to health and ecosystem services (e.g., dollars). Restoration or preservation of habitat, wetlands, biodiversity, watersheds, forests, endangered species, etc. could be measured in terms of area (e.g., hectacres), or in terms of ecosystem services or other revenue (e.g., dollars). Restoration or protection of endangered species could be measured in terms of ecosystem services or lost tourism revenue (e.g., dollars). Restoration or protection of socio-economic or community resources could be measured in dollars.

From these impacts, a number of micro-units of positive environmental impact associated with the project are calculated 406 by dividing the number of units of positive environmental impact associated with the project by the negative environmental impact corresponding to the retail item, each micro-unit representing a portion of the units of positive environmental impact equal to the negative environmental impact corresponding to the retail item. For example, imagine a project for removing CO2 from the atmosphere via terrestrial plants by way of a reforestation project. For the purposes of this example, assume the entire project removed 20 metric ton (t) of CO2 from the atmosphere. Further assume the retail item is a gallon of milk, with an estimated carbon footprint of 6.19 pounds of CO2 per gallon jug.

An exemplary calculation:

20 t×2,204.6 (pounds per t)=44,092 units (pounds) CO2 in reforestation project 44,092 (units)/6.19 per retail item (pounds in a gallon of milk)=7,123.10 micro-units (each corresponding to a single gallon of milk)

In an alternative embodiment, one or more standardized micro-unit values are established. Examples might be a milk micro-unit value (e.g., based on 6.5 pounds of CO2 per micro-unit), a shoe micro-unit value (e.g., based on 95 pounds of CO2 per micro-unit), and a laundry detergent micro-unit value (e.g., based on 2 pounds of CO2 per micro-unit).

Once the number of micro-units are calculated 406, a unique identifier is assigned 408 to each of the micro-units. If immediate information is not available about the pairing of the micro-units with the retail items, then this step may include an initial identification of a set of unique identifiers equal in number to the number of micro-units for the project. If the retail item information is available, the assignment 408 includes pairing each micro-unit, by its unique identifier, to a retail item, e.g., by its retail identifier such as a serial number or lot number. In some examples the assignment 408 is not one-to-one, e.g., in the standardized micro-unit example above in which the positive impact of the micro-units may not perfectly match the negative impact of retail items. Thus, in some instances multiple micro-units may be assigned to a single retail item, or multiple retail items may be assigned to a single micro-unit (e.g., for a batch or lot of the retail items).

Once paired, the association information is stored 410. The information may be stored in a database local or remote to the offset manager 102 (e.g., database 108). The association information may be accessible at various levels for various purposes. For example, a producer or manufacturer may want to access the information for reporting, marketing, or product labeling purposes. In addition, a third party 110, such as a consumer of the retail item, a standards or regulatory agency, etc. may want to access the various data associated with the retail item-micro-unit pairing. Access can be any of the methods described in conjunction with database 108.

According to one embodiment, negative impact-positive impact pairings are brokered by the offset manager 102. When a retail producer 106 wants to offset a particular good or service, the can do so with professional assistance from the offset manager 102. The offset manager 102 can advise the retailer 106 regarding sizes of positive environmental impact projects, timing of projects, verification status and procedures, tracking details, etc., and helps the retailer 106 find a project that is a good fit for the retailer's offset goals. The offset manager 102 may perform some of the brokering functionality via hardware, software, and/or systems designed to programmatically guide such decisions. In an alternative embodiment, a consumer could purchase the micro-offset directly from the offset manager 102.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims. All scientific papers, patents, and other referenced documents are hereby incorporated by reference in their entirety for all purposes.

What is claimed is:

1. A computer-implemented method of offsetting negative environmental impacts associated with retail items, comprising:
determining a negative environmental impact associated with a retail item;
determining a number of units of positive environmental impact associated with a selected project;
calculating a number of micro-units of positive environmental impact associated with the project by dividing the number of units of positive environmental impact associated with the project by the negative environmental impact corresponding to the retail item, each micro-unit representing a portion of the units of positive environmental impact equal to the negative environmental impact corresponding to the retail item;
assigning a unique identifier to each of the number of micro-units, the unique identifiers for association with a number of retail items equal to the number of micro-units; and
storing association information for pairings of the unique identifiers with the number of retail items.

2. The computer-implemented method of claim 1, further comprising making available the stored association information for the pairings.

3. The computer-implemented method of claim 2, wherein the association is available via a Uniform Resource Locator.

4. The computer-implemented method of claim 1, wherein a selected unique identifier is used for labeling a selected retail item.

5. The computer-implemented method of claim 1, wherein the association information is coded into the UPC code for retail item.

6. The computer-implemented method of claim 1, wherein the negative environmental impact associated with the retail item is provided to a third party for display on a retail record.

7. The computer-implemented method of claim 1, wherein the negative environmental impact is from carbon dioxide, the positive environmental impact is carbon sequestration, and the units of positive environmental impact are tons of carbon dioxide.

8. A computer system for offsetting negative environmental impacts associated with retail items, comprising:
a processor;
a negative impact module for determining a negative environmental impact associated with a retail item;
a positive impact module for determining a number of units of positive environmental impact associated with a selected project;
a micro-unit calculation module for calculating a number of micro-units of positive environmental impact associated with the project by dividing the number of units of positive environmental impact associated with the project by the negative environmental impact corresponding to the retail item, each micro-unit representing a portion of the units of positive environmental impact equal to the negative environmental impact corresponding to the retail item;
an assignment module for assigning a unique identifier to each of the number of micro-units, the unique identifiers for association with a number of retail items equal to the number of micro-units; and
and a storage module for storing association information for pairings of the unique identifiers with the number of retail items.

9. The computer system of claim 8, the storage module further configured for making available the stored association information for the pairings.

10. The computer system of claim 9, wherein the association is available via a Uniform Resource Locator.

11. The computer system of claim 8, wherein a selected unique identifier is used for labeling a selected retail item.

12. The computer system of claim 8, wherein the negative environmental impact associated with the retail item and information identifying the number of retail items is provided by a retail producer of the retail items.

13. The computer system of claim 8, wherein the negative environmental impact associated with the retail item is provided to a third party for display on a retail record.

14. The computer system of claim 8, wherein the negative environmental impact is from carbon dioxide, the positive environmental impact is carbon sequestration, and the units of positive environmental impact are tons of carbon dioxide.

15. A computer program product for offsetting negative environmental impacts associated with retail items, comprising:
a computer readable storage medium;
computer program code, stored on the storage medium, for:
determining a negative environmental impact associated with a retail item;
determining a number of units of positive environmental impact associated with a selected project;
calculating a number of micro-units of positive environmental impact associated with the project by dividing the number of units of positive environmental impact associated with the project by the negative environmental impact corresponding to the retail item, each micro-unit representing a portion of the units of positive environmental impact equal to the negative environmental impact corresponding to the retail item;
assigning a unique identifier to each of the number of micro-units, the unique identifiers for association with a number of retail items equal to the number of micro-units; and
storing association information for pairings of the unique identifiers with the number of retail items.

16. The computer program product of claim 15, further comprising computer code coded on the medium for making available the stored association information for the pairings.

17. The computer program product of claim 16, wherein the association is available via a Uniform Resource Locator.

18. The computer program product of claim 15, wherein the negative environmental impact associated with the retail item and information identifying the number of retail items is provided by a retail producer of the retail items.

19. The computer program product of claim 15, wherein the negative environmental impact associated with the retail item is provided to a third party for display on a retail record.

20. The computer program product of claim 15, wherein the negative environmental impact is from carbon dioxide, the positive environmental impact is carbon sequestration, and the units of positive environmental impact are tons of carbon dioxide.
